(19) United States
(12) Patent Application Publication
(10) Pub. No.: US 2015/0221208 A1
(43) Pub. Date: Aug. 6, 2015

(54) Sanitation Dispenser System and Program

(71) Applicants: Shanina Knighton, Euclid, OH (US); Robert Knighton, III, Euclid, OH (US)

(72) Inventors: Shanina Knighton, Euclid, OH (US); Robert Knighton, III, Euclid, OH (US)

(21) Appl. No.: 14/682,554

(22) Filed: Apr. 9, 2015

Related U.S. Application Data
(63) Continuation-in-part of application No. 13/796,027, filed on Mar. 12, 2013, now abandoned.
(60) Provisional application No. 61/685,107, filed on Mar. 12, 2012.

(51) Int. Cl. G08B 21/24; G06F 19/00

(52) U.S. Cl. CPC G08B 21/245; G06F 19/327

(57) ABSTRACT

A hand sanitizer dispenser having a dispenser mechanism. The device may be microprocessor controlled and may time stamp and log actuations of the dispenser mechanism. Log entries may be associated or correlated with a patient and may be recorded in the patient's electronic medical records. The dispenser may also include an audio component adapted to issue verbal reminders and tonal reminders from a schedule of reminders. The schedule of reminders may be derived from entries in the patient's electronic medical records such as meal times, appointments with specialists, and other triggering events where hygiene may be advantageously practiced.

### I. CROSS REFERENCE TO RELATED APPLICATIONS

This application is a continuation-in-part claiming the benefit of U.S. patent application Ser. No. 13/796,027 filed on Mar. 12, 2013 and now pending, which in turn claims the benefit of U.S. Provisional Patent Application No. 61/685,107 filed Mar. 12, 2012 and now expired, both of which are incorporated herein by reference in their entireties. This application also incorporates in its entirety U.S. Utility patent application Ser. No. 13/068,906 filed Oct. 11, 2011 and now expired, and U.S. Provisional Patent Application No. 61/630,976 filed on Dec. 23, 2011 and now expired.

### II. BACKGROUND OF THE INVENTION

A. Field of Invention

Some embodiments may generally relate to hand sanitizer devices and/or systems.

B. Description of the Related Art

Poor or inadequate hand washing and/or hand hygiene is known to be problematic in hospital settings, and is a major source of infections contracted while patients are admitted to a hospital. While hand washing and hygiene policies and training are important and can be effective in reducing the spread of infections, the problem of infections due to unsatisfactory hygiene of staff, medical professionals, and even patients continues to be problematic. It is known to place hand washing stations and hand sanitizer dispensers throughout medical facilities including in examination rooms, hallways, lobbies, and even patient rooms. However, such systems are purely mechanical and are incapable of providing an automated means of establishing accountability for good hygienic practices. Infection prevention is multifactorial and may require a systematic approach involving the simple practice of hand hygiene on all fronts: the healthcare worker, visitors, and the patient. To date, much of the research and many of the institutional infection control changes around hand hygiene have focused on the link between hospital-acquired infections and the hands of healthcare workers. Few existing products are specifically designed for patient use or address patients' unique hand hygiene needs. What is needed is an automated means for establishing patient accountability for good hygienic practices, and to promote good hygienic habits. Some embodiments of the present invention may provide one or more benefits or advantages over the prior art.

### III. SUMMARY OF THE INVENTION

Some embodiments may relate to a hand sanitizer dispenser, comprising: a dispenser mechanism in fluid communication with a reservoir adapted to contain hand sanitizer liquid; a microprocessor in electronic communication with the dispensing mechanism and adapted to detect actuation events of the dispensing mechanism, time stamp the actuation event, and record the time stamped actuation event in a data storage component of the dispenser, wherein the microprocessor is further adapted to upload the recorded time stamped actuation event to a remote computer in a format compatible with recording in an electronic medical record of a patient; and an audio component adapted to issue verbal reminders and tonal reminders from a schedule of reminders, wherein the reminders are derived from a entries in the patient's remote electronic medical record.

Embodiments may further comprise a reader adapted to read an electronic signal identifying a patient.

According to some embodiments the reader is adapted to read electronic signals from a source selected from one or more of a passive RFID tag, an active RFID tag, a radio frequency beacon, a Wi-Fi beacon, a Bluetooth Low Energy beacon, or a Near Field Technology chip.

Embodiments may be further adapted to correlate the actuation event with the signal identifying the patient.

According to some embodiments the source of the electronic signals identifying a patient comprises a bracelet, a ring, an adhesive patch, or a subcutaneously implantable device.

Embodiments may further comprise indicia identifying the dispenser to a network.

According to some embodiments the schedule of reminders is stored onboard the dispenser.

According to some embodiments the schedule or reminder is not stored onboard the dispenser.

Embodiments may further comprise a detector grid for locating the patient.

According to some embodiments the dispenser is adapted to receive scheduled reminders from the remote computer when the patient is detected nearby the dispenser.

According to some embodiments the dispenser is further adapted to cache the recorded time stamped actuation event.

Embodiments may further comprise an ad hoc network interface adapted to communicate with nearby dispenser units.

According to some embodiments the ad hoc network interface is adapted to route data from a first remote dispenser to a second remote dispenser, or to the remote computer system.

According to some embodiments the patient's usage of the dispenser is recorded by the remote computer in the patient's electronic medical record.

According to some embodiments the patient's failure to use the dispenser in accordance with a scheduled reminder is recorded by the remote computer in the patient's electronic medical record.

According to some embodiments generation of the schedule of reminders can be suspended if the patient's electronic medical record indicates that the patient is not capable of using the dispenser.

According to some embodiments the dispenser comprises one of a plurality of dispensers adapted to upload time stamped actuation events of the patient to the remote computer.

Embodiments may further comprise a system adapted to collect hand sanitizer usage data associated with one or more patients and statistically analyze the data.

Embodiments may further comprise a system adapted isolate an in-house source of infection by analyzing hand sanitizer usage data and electronic medical records of a plurality of patients.

Other benefits and advantages will become apparent to those skilled in the art to which it pertains upon reading and understanding of the following detailed specification.

### IV. BRIEF DESCRIPTION OF THE DRAWINGS

The invention may take physical form in certain parts and arrangement of parts, embodiments of which will be described in detail in this specification and illustrated in the accompanying drawings which form a part hereof and wherein:

FIG. 1 is a schematic diagram of a dispenser according to an embodiment;

FIG. 2 is a schematic diagram of a hand sanitizer system according to an embodiment;

FIG. 3 is a flowchart of a process which may be carried out by or in association with an embodiment;

FIG. 4 is a flowchart showing how reminders may be generated and used according to one embodiment; and

FIG. 5 illustrates an embodiment where an ambulatory patient is recognized by a plurality of dispenser units.

### V. DETAILED DESCRIPTION OF THE INVENTION

Embodiments may include a hand sanitizer dispenser and/or hand sanitizer system. A dispenser may include a dispensing mechanism, for discharging hand sanitizer from the dispenser according to any of a variety of mechanisms known in the art. A dispenser may also include a microprocessor adapted to control one or more electronic components of the hand sanitizer dispenser. One such electronic component may include a counter that electronically communicates with the dispensing mechanism and counts each actuation event of the dispensing mechanism. As used herein, an actuation event includes an action of the dispensing mechanism that dispenses hand sanitizer. An actuation event may be interchangeably referred to herein as a use of the dispenser or a use event. A dispenser may also include one or more electronic data storage components, which may be in electronic data communication with the counter and/or with the microprocessor. The electronic data storage components may operate under the control of the microprocessor and may be adapted to receive and record count data from the counter. A dispenser may also be adapted to identify a user of the dispenser, and may record indicia identifying the user in association with an actuation event. Embodiments may also include a data port adapted to communicate electronically with a remote computer system external the embodiment, for instance, through a computer network.

A suitable electronic data storage component can include volatile or nonvolatile hardware components for storing electronic data including, without limitation, magnetic media, hard disk drives, flash memory, random access memory, optical disks and the like. One skilled in the art will appreciate that one or more of these media may be appropriate depending on the specific device application, the nature of the data being collected, and other device features or requirements which may be desirable in addition to those set forth herein.

Suitable adaptations for identifying a user may include, without limitation, a radio frequency identification (RFID) tag, wireless beacons such as Bluetooth beacons or Wi-Fi beacons, near field communications (NFC) components, or other wireless signaling means. In some embodiments, a patient may be assigned to a particular dispenser device such as a bed-mounted dispenser. For instance, an embodiment may retrieve a patient bed and/or dispenser assignment from a patient's electronic medical record; accordingly, the dispenser device may recognize any use of the device as use by the patient. In other embodiments, an RFID tag may be embedded in a hospital bracelet and may be uniquely encoded to identify an individual such as a patient or medical personnel who may interact with the patient. Accordingly, a dispenser device would recognize a user according to their RFID tag, and would record usage data in association with the user's profile or electronic medical record as appropriate.

It will be understood that recording dispenser usage data in a patient's electronic medical record may take various forms. In some embodiments it will be advantageous to record such events as Activities of Daily Living notes. Furthermore, the data recorded may be fed back to the patient in a form that permits him to understand whether he is effectively complying with hygiene standards or is falling short. This may be useful according to Self-Management methodologies of the Meaningful Use Stages I through III medical data standards, which may enable the user to alter his behavior to better ensure or optimize his own health. Additionally, the data may be useful to a hospital for the purpose of establishing whether a patient may have brought on a medical condition such as an infection through his own actions, e.g. non-adherence to a prescribed hygiene program.

Furthermore, a hospital may advantageously aggregate the data collected from units throughout a hospital to isolate the likely source of an infection. For instance, if Patient A has a particular infection such as a staph infection, and Patient B located two floors away later develops the same infection, A may be determined to be the source of B's infection if it is found that Nurse X treated A and B without creating a record of having cleaned his/her hands. It will be understood that such data becomes more meaningful as more data is collected. For instance, Nurse X may be more tightly correlated as the vehicle for spreading infection if the pattern between A and B is also repeated with Patients C, D and E.

According to embodiments that include RFID tags, a passive RFID tag must be within a predetermined distance from the dispensing device so that only the hand of a user in the act of actuating the device will be recognized by the RFID tag reader. Therefore, the usage data would be recorded in association with a profile or electronic medical record of the individual whose RFID tag was read. Such an arrangement may be desirable for ensuring that only an RFID tag of a user in the act of using the dispenser is read by the RFID reader. A suitable distance between of the RFID tag from the dispensing means or an actuator thereof may be between about 12 inches and about 1 inch, and it would be within the skill of the art to determine a proper distance for reading an RFID tag or other electronic indicia. Other suitable distances may include one or more of about 12 to 11 inches, 11 to 10 inches, 10 to 9 inches, 9 to 8 inches, 8 to 7 inches, 7 to 6 inches, 6 to 5 inches, 5 to 4 inches, 4 to 3 inches, 3 to 2 inches, or 2 to 1 inches. Here as elsewhere in the specification and claims, ranges may be combined.

In contrast to RFID and NFC enabled devices for identifying users of a dispenser, electronic beacon technologies operate over longer distances. Therefore, certain measure may be required in order to be sure to properly identify users when a plurality of beacons are within range of the dispenser device. One approach is to turn a user's beacon on only when he is in the act of using the dispenser. Another approach is to allow the beacon to transmit continuously but assign usage to the beacon having the strongest signal, indicating the closes proximity.

Embodiments of the invention may be adapted to record a user identification signal, such as that of an RFID tag, in association with an actuation event count. As used herein the term “in association with” in regard to recording data in electronic media includes structuring the data in such a way that a logical association is created so that a particular actuation event can be accurately attributed to a particular user. Embodiments may include methodologies for correlating an actuation event with a user ID signal as will be apparent to those skilled in the art. For instance, in some embodiments a correlation can be established if an actuation even occurs within a predetermined amount of time of receiving a user-identifying signal such as an RFID reading. Conversely, if an RFID reading is received by an embodiment, but the reading cannot be correlated to an actuation event, then the RFID reading may be disregarded or erased from memory. In another embodiment, correlations may not be necessary because a patient may be assigned to a given dispenser unit according to hospital records of the patient's bed assignment.

Optionally an embodiment may include a feature whereby a dispensing mechanism can only actuate if a user-identifying signal is first received. Alternatively, rather than blocking actuation, an unidentified user may instead receive hand sanitizer in addition to some negative indicia such as a red LED light or buzzer that indicates an unexpected use of the device. Unexpected uses may or may not be recorded in the electronic data storage components. It may be beneficial to record as guest uses those which are not associable with a user-identifying signal. For instance, visitor to a patient's room may use a bedside-mounted unit without an RFID tag indicating the person's identity, but the usage would be logged as use by a guest.

It will be understood that a patient may be moved from one bed to another within a hospital as his/her medical needs change. For instance, a patient admitted to the hospital through the emergency room for an acute injury may initially be assigned to a bed in an intensive care unit, but his condition may later be upgraded and he may be transferred out of the ICU to another bed. Accordingly, embodiments may be adapted to update the patient's location. For instance, in one embodiment, hospital staff may enter the patient's new bed assignment into an electronic medical chart or electronic medical record, which may cause the patient to be assigned to a dispenser associated with the new bed. In other embodiments, a new dispenser may automatically recognize the patient based on an identifying signal such as an RFID, NFC, or wireless beacon signal.

Furthermore, patients who are mobile may benefit from being tracked within a hospital as they move about a floor for instance, and may receive their reminders from units other than the one mounted to his or her bedside. As one example, a patient may be fitted with a tracking device and the patient's position may be tracked according to known methods as he moves about a facility. Suitable tracking devices include, without limitation, Wi-Fi beacons, Bluetooth beacons, satellite-based triangulation technologies, Global Positioning System (GPS), and the like. If an event triggering a reminder to use a dispenser occurs while the patient is away from his assigned bed, an embodiment may determine which dispenser unit is nearest the patient's current position and route the reminder to that unit, along with a verbalization of the patient's name. For example, as patient Smith passes a dispenser of an embodiment located in a hallway he may receive the message “Mr. Smith, your dinner will be served in five minutes. It is time to clean your hands.” If Mr. Smith then actuates the dispenser, the actuation event may then be recorded in Mr. Smith's electronic medical record, e.g. as an Activity of Daily Living note.

Embodiments may include audible and/or visible reminders issued to a patient to use the system in accordance with a predetermined hygiene plan. Audible reminders may be as simple as a beep or tone indicating that the dispenser device should be used; however, embodiments may include verbal messages containing specific details, such as “dinner is in five minutes; it is time to clean your hands”. Furthermore, the reminders may be generated based on triggering events that are entered into a patient's electronic medical records and/or electronic chart. For instance, certain events such as meal times, appointments with physical therapists, scheduled examinations, or regular hospital rounds, etc. may be entered into the patient's electronic medical records and/or electronic chart and may be scheduled to occur at predictable times. Accordingly, the patient may be reminded to use the dispenser at the time of the event, or shortly before the event is scheduled to occur.

It will be understood that some events are not amenable to scheduling, but a patient would still benefit from a reminder. For instance, it may be beneficial to the patient to use the dispenser after using the bathroom or after touching a wound, but such events tend to be spontaneous. Accordingly, some embodiments may include periodically issuing a reminder to the patient to wash his hands before or after such events. More particularly, it is contemplated that such a reminder would be verbal, comprising a prerecorded or synthesized audible message.

Some embodiments may account for conditions where a patient should not be expected to use a dispenser unit. For example, a clearly comatose patient could not be reasonably expected to adhere to any hygiene policy. Thus, embodiments may draw on certain known methodologies for ascertaining a patient's ability to move about and make decisions. Some of these known methodologies include the Glasgow Coma Scale (GCS), the Braden Scale (BS), and Awareness and Orientation (e.g. x1, x2, or x3). It will be within the skill of the medical arts for a physician to examine a patient and assess whether the patient is capable of using a dispenser unit. Thus, in some embodiments a patient's hygiene program may be suspended if an attending physician or other medical professional specifically assesses the patient as incapable of adhering to the program. In other embodiments, the patient's ability to adhere to a hygiene program may be inferred from his scores on one or more of the foregoing tests or based on another test known in the art. For example, a Braden Scale mobility score of 1 indicating that the patient is completely immobile may cause a hygiene program to be suspended regardless of how the patient scores on any other component of the Branden Scale. Just as a patient's hygiene program may be suspended, it may also be reinstated if his condition improves.

As previously stated herein, embodiments may include a data port for communicating with a remote computer system. As used herein the term remote computer system can include a computer accessible by known methodologies through a network interface connection including, without limitation, Ethernet, cellular modem, and/or Wi-Fi; however, a remote computer system may also include a computer which communicates directly or indirectly with a data port such as through USB, telephone line, serial port, parallel port connection, or according to other known means.

It is contemplated that embodiments may be deployed in a number of different topologies. For instance, in one embodiment a plurality of dispenser units may be disposed throughout a hospital or healthcare facility and may communicate electronically with a centralized computer system. In such embodiments, usage data generated by a patient or healthcare worker may be uploaded as it occurs or periodically. It will be understood that caching usage data may be advantageous because computer networks are known to fail from time to time. Accordingly, data loss may be prevented by locally caching it on-board a dispenser unit until network communication can be reestablished. In another network topology, dispenser units may form an ad hoc network or may form a wireless swarm according to known methods. Accordingly, so long as at least one dispenser unit is capable of communicating with a central server, all of the dispenser units may communicate with the central server by passing data through the ad hoc network or swarm.

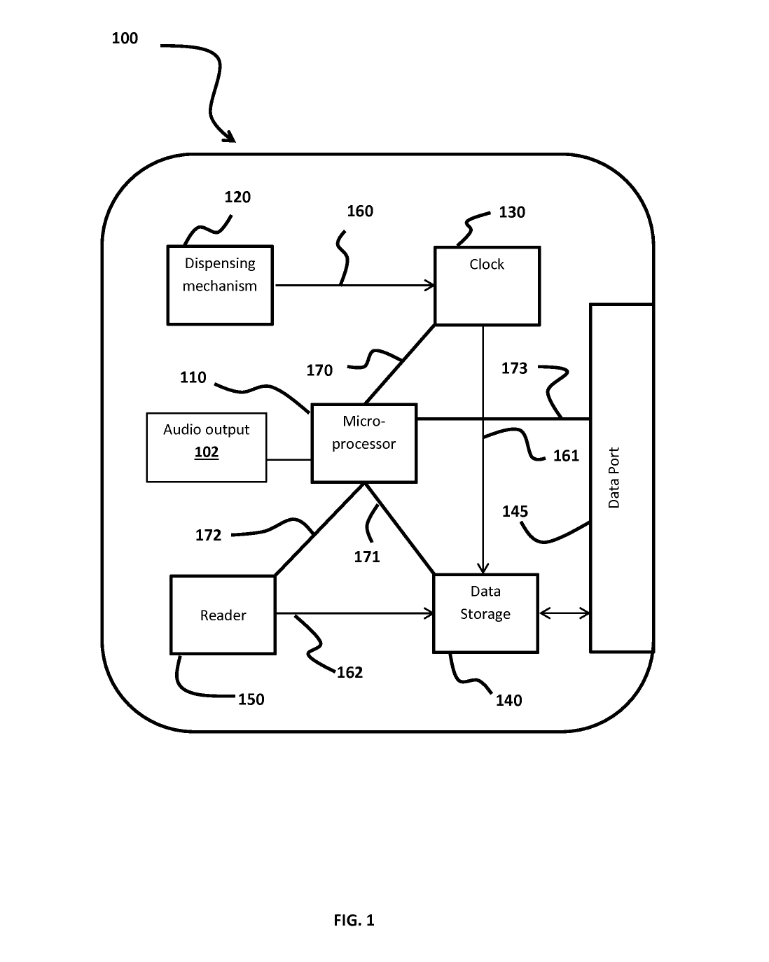

Referring now to the drawings wherein the showings are for purposes of illustrating embodiments of the invention only and not for purposes of limiting the same, FIG. 1 is a schematic diagram of a hand sanitizer dispenser 100 according to one embodiment of the invention. The dispenser 100 of FIG. 1 includes a microprocessor 110 which is in electronic communication 170 with a clock 130. As used herein, the term electronic communication may include electronic data communication, electronic controlling communication, or both. The clock 130 communicates 160 with a dispensing mechanism 120 and is adapted to time stamp each actuation event. The clock communicates 161 time stamped actuation events to the data storage component 140.

One skilled in the art will appreciate that the log data may be routed through the microprocessor 110 where it may be processed, or the log data may be communicated directly to the data storage component 140 in cooperation with the microprocessor 110. Particularly, one skilled in the art will appreciate that the microprocessor 110 may actually comprise a plurality of cooperating microprocessors wherein electronic components of the dispenser mechanism 120, such as the clock 130, data storage components 140, data port 145 and/or reader 150, may have their own microprocessor(s) which may perform analog-to-digital conversions, signal transformations, or other advantageous functions.

Further according to FIG. 1, the microprocessor 110 may include a clock circuit; therefore a separate clock element 130 may not be necessary. The dispenser 100 of FIG. 1 also includes a reader 150 adapted to read a signal identifying a user of the device. As previously discussed herein, suitable technologies for generating and reading user-identifying signals can include, without limitation, active or passive RFID, radio frequency beacons, near field technology, and the like. The reader 150 is in electronic communication 172 with the microprocessor 110. RFID data which is read from a chip may be communicated 162 to the data storage component 140 and may be recorded therein in association with actuation event log data to which it correlates. Notwithstanding FIG. 1, the reader element 150 is optional. Some embodiments may omit the reader 150 if a patient is assigned to (i.e. associated with) a particular dispenser unit. In such embodiments, all uses of the dispenser are presumed to be that of the assigned patient. Accordingly, the rather than logging a patient's use in association with the patient's identity, the patient's identity may be inferred from an identifying indicia of the dispenser such as an IP address or MAC address.

Similar to the clock 130, the reader 150 may be adapted to route its data signal through the microprocessor 110 where it may be processed, or it may be communicated directly to the data storage component 140 in cooperation with the microprocessor 110. Accordingly, the data storage component 140 may include time-stamped log data and user-identifying data which correlates to the log data. Thus, each log entry can be accurately attributed to a particular user. Finally, the dispenser of FIG. 1 also includes a data port 145 which may be logical or physical, and which is in data communication with the data storage component 140 and in electronic communication 173 with the microprocessor 110. Data stored in the data storage component 140 may be communicated to computer systems external to the embodiment 100 through the data port 145. Conversely, the embodiment 100 may receive data from external computer systems or from other dispenser devices (e.g. in an ad hoc or swarm deployment) through the data port 145.

FIG. 1 also includes an audio component 102 in electronic communication with the microprocessor 110. An audio component may be adapted to issue reminders such as verbal reminders, or simple tones or combinations of tones. Accordingly, an audio component 102 may include a speaker and may also include sound processing electronic components. One skilled in the art will appreciate that depending on the sophistication of the microprocessor 110 chosen for a given design, the audio output component 102 may or may not require electronics for processing sound. Furthermore, the output of the audio output component 102 may result from reminders queued and/or scheduled according to entries in a patient's electronic medical record such as known meal times and appointments. The reminders may or may not be stored onboard the dispenser 100, but in embodiments where onboard storage of reminder schedules is enabled, the data storage component 140 may be used for this purpose.

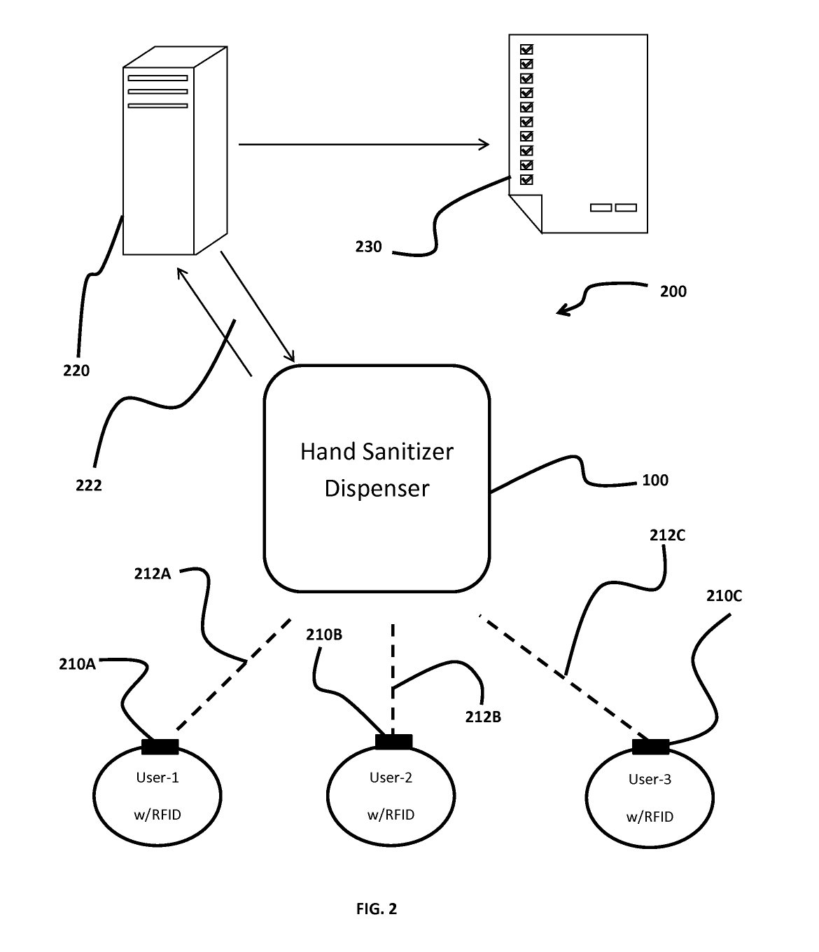

FIG. 2 is a schematic diagram of a hand sanitizer system 200 according to an embodiment. As shown, the hand sanitizer dispenser 100 is in bidirectional communication 222 through the data port 145 with an external computer system 220. Additionally, a plurality bracelets embedded with RFID chips 210A, 210B, 210C are affixed to user-1, user-2, and user-3. Each RFID chip 210A, 210B, 210C is encoded with unique identifying signals 212A, 212B, 212C such that the users can be discerned from one another. When a user attempts to actuate the dispenser 100, he/she reaches toward the dispenser 100 with the hand bearing the RFID bracelet 210A, 210B or 210C which is read by the RFID reader 150 of the dispenser 100. Provided that an actuation event is recorded within a predetermined time thereafter, the RFID signal will be correlated to the actuation event and will be recorded in relation to the actuation event data along with an optional time stamp. The data recorded in this manner may be uploaded to the remote computer system 220 and may be used to generate reports 230 which may assist a medical facility with conceptualizing the data and deriving meaning from it. The remote computer system 220 may also record the log data in a patient's electronic medical records. Furthermore, remote computer 220 may use entries in a patient's electronic medical records to schedule reminders that will be issued by the hand sanitizer dispenser 100. It will be appreciated that reminders may be stored locally on a dispenser device 100 and/or may be stored on the remote computer 220. In embodiments where a patient may be expected to use more than one dispenser device 100 it may be particularly advantageous to maintain a schedule of reminder triggering events on the remote computer 220 so that reminders may be issued to a dispenser nearest the patient's current location.

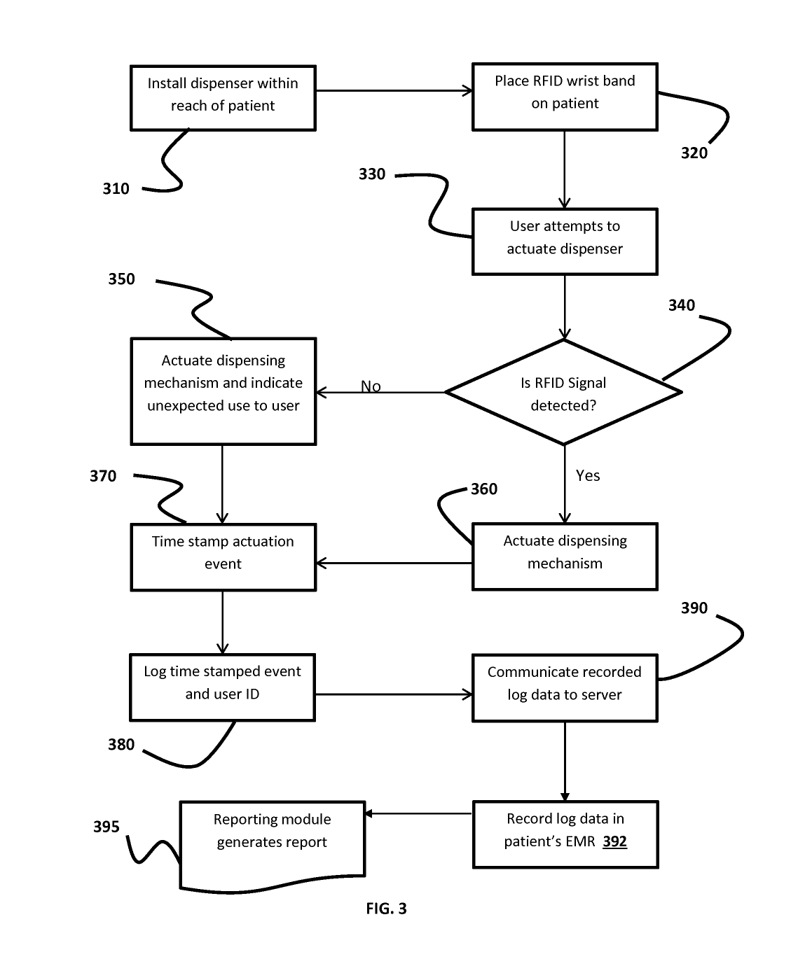

FIG. 3 illustrates a method which may be carried out by, or in association with, an embodiment 100 and/or system 200. Although FIG. 3 specifically illustrates an embodiment employing an RFID wrist band, it will be understood upon reading the entire disclosure herein that this is merely illustrative and that other technologies could be substituted for RFID. According to the method of FIG. 3, a dispenser 100 is installed 310 within reach of a patient. For instance, it may be mounted to the bed side rail, or to a nearby structure within arm's reach. An RFID bracelet is placed on the patient, preferably on the wrist most proximal to the dispenser 100. The patient/user then reaches toward the dispenser 100 to actuate the dispenser 100 and receive hand sanitizer, and when the RFID chip is sufficiently near the dispenser 100, it is detected and read 340 by the RFID reader 150 of the dispenser 100, and the dispensing mechanism is actuated 360. The user-identifying RFID data read by the dispenser 100 may be time stamped 370 and recorded 380 in association with the actuation event. Alternatively, if no RFID signal is detected and/or readable 340 prior to the actuation event then the dispenser 100 produces feedback for the user indicating unexpected use 350; however, the dispenser 100 still provides hand sanitizer 350 in this particular embodiment. In either case 350 or 360, the actuation event is time stamped 370 and recorded 380.

In some embodiments the actuation event data and the RFID data may be subjected to a correlation protocol to determine whether the actuation event can be reliably attributed to an identified user. For instance, if the system determines that the RFID data was read with an allowable time window relative to the actuation event then the two may be correlated. Additionally or alternatively, embodiments may use signal strength to correlate a user to an actuation event, e.g. as in the case of using a radio frequency beacon rather than RFID.

If the actuation event is correlated to a user then the event data and user-identifying data, and time stamp may be recorded 380 in relation to each other in the data storage means 140. This data may be accumulated and stored onboard the dispenser 100, e.g. in a buffer, or may be transmitted 390 directly to a remote computer system 220 through the data port 145. The data may then be recorded in a patient's electronic medical record (EMR) 392 and/or used to produce reports 395.

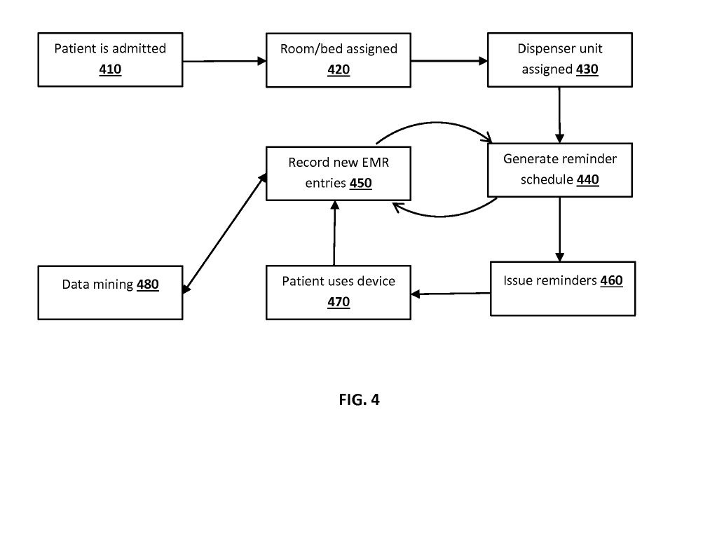

FIG. 4 is an illustration of a process whereby an embodiment is integrated with patient admission. According to a first step 410 the patient presents himself to a healthcare facility such as a hospital and is admitted. According to typical practice, during admission a patient's information is collected and recorded in an electronic chart or electronic medical record. The record may be include an admission/discharge/transfer (ADT) record. Furthermore, the specific data collected may include identifying information, vital signs, demographic data, symptoms, insurance data, patient classification codes, accommodation codes, and the like. In a second step, a room and bed may be assigned 420 and recorded in the patient's electronic chart. In a third step 430, the patient is associated with a bedside mounted hand sanitation dispenser according to his bed assignment 420. It will be understood that a dispenser assignment may occur automatically when a bed is assigned. It will also be understood upon reading the totality of the present disclosure that the step of assigning a dispenser is one of a plurality of embodiments, some of which require no such assignment. In a fourth step, an embodiment uses events recorded in a patient's electronic medical record to generate a schedule of reminders 440 to use the dispenser device. The nature of these events have been discussed in detail herein, and can include meal times, appointments with specialists, bathroom visits, and the like. In step 450, the patient's electronic medical record is updated from time to time as new information is collected such as test results, diagnoses, treatment regimens, meal times, appointments within the facility, and the like. In step 460, the embodiment issues reminders to the patient according to the reminder schedule. Reminders may be verbal prerecorded messages or synthesized voice messages, or the reminders may be simple tones or sounds. Visual reminders may be appropriate for, deaf or hard-of-hearing patients. Step 470 represents the patient using the dispenser device, possibly in response to a reminder. The usage event may then be time stamped and logged in the patient's electronic medical record 450. According to step 480, logs of the patient's usage of the dispenser device may be mined from his electronic medical records and used for conducting a wide variety of statistical analyses and generating reports, with respect to the individual patient and/or the broader patient population.

Compiling patient hand hygiene data in patient's electronic medical records enhances the ability to conduct epidemiological studies, which may uncover statistical relationships for preventing the spread of disease. For instance, embodiments enable healthcare providers to correlate hand hygiene data of patient populations with other data already being captured from patients such as demographics, co-morbidities, Braden Scale, or Glascow Coma Scale components, age, diagnosis, mobility score, disease etc., which may result in new insights for preventing disease. For instance, it may be found that the lives of hospice patients may be extended by improving hand hygiene at key times. Similarly, the foregoing data can also be aggregated with hospital-acquired infection data, hand hygiene of healthcare staff, rate of infectious diseases, and so on. Doing so draws the patient in as an active participant in infection prevention along with healthcare professionals.

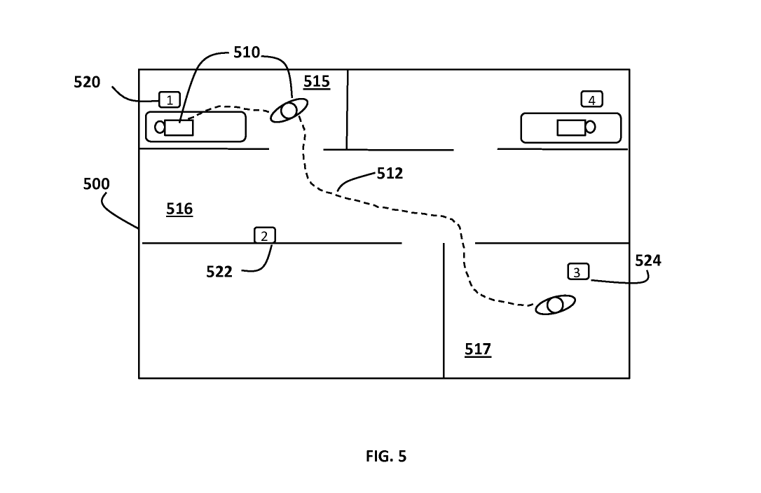

FIG. 5 illustrates an embodiment wherein a patient 510 is assigned to a room 515. The patient 510 travels 512 from his room 515 through a hallway 516 to a shared restroom 517. The patient 510 has a first hand sanitizer dispenser 520 located in his room 515, but also passes a second dispenser 522 in the hallway 516 on his way to a restroom 517, where there is a third dispenser 524. Since the patient 510 is ambulatory he may use any or all of the dispensers 520, 522, or 524. In order to be sure that his usage of the dispensers is properly logged in his electronic chart the dispensers 520, 522, 524 may recognize the patient according to an electronic identifier which may be a radio frequency beacon such as a Bluetooth Low Energy (BLE), Wi-Fi, or iBeacon technology. Furthermore, the facility 500 may be equipped with a detector grid for sensing the location of the patient 510 within the facility 500. Accordingly, an embodiment may be capable of determining which dispenser is nearest to the patient 510 and any given moment. Therefore, if a reminder event comes due, the embodiment may locate the patient 510 and issue a verbal reminder to the patient from a nearby dispenser rather than necessarily issuing the reminder from the patient's bedside dispenser unit 520. Similarly, if the embodiment detects that the patient 510 is in the bathroom 517 it may issue a verbal reminder to the patient 510 to clean his hands before leaving the bathroom 517. Accordingly, in this instance the reminder event is generated and added to the patient's electronic medical record in real time in response to an action of the patient.

Embodiments include a tracking and information system geared towards healthcare facilities integrated with a hand sanitizer dispenser having the capability to collect data, perform frequent reminders, and relay information to a user. The tracking system is capable of collecting data regarding usage of a hand sanitizer dispenser and storing the data on the hand sanitizer dispenser and/or uploading the data into a remote server or database. Embodiments adapted to upload data to a remote server will comprise a microcontroller and software which cooperate to process signals from a sensor identification unit associated with an individual (e.g. patient, staff member, customer, or resident) and a scanning device on board the sanitizing dispenser for detecting sensor identification unit and thus track usage of the sanitation dispenser by particular individuals wearing the sensor identification units. For example, in one embodiment a sensor identification unit may be a technology that may be placed in a wrist band such as a patient identification band. Thus, when the individual's hand with the attached wristband comes in close proximity to the dispenser, the scanning device will scan the identification data from the sensor device and send it back to a main computer that will keep track of the individual's hand sanitizer usage. Frequent reminders may be programmed into the dispenser and may be periodic. The reminders may include a voice, digital readout display, or audible reminder to use the hand sanitizer dispenser at certain predetermined times (e.g. meals, one hour after meals, and random times). For better accuracy, the device will have a three minute shutoff after the initial use.

In the hospital industry research and tracking of hand sanitizer usage has become one of the most important practices in day to day operations. Data tracking software will upload tracking data collected by embodiments into a database that will organize the information, and calculate key statistical parameters that will help the hospital monitor hand hygiene compliance. The data will be available for viewing through a secure website. The website will allow real time tracking or time-delayed tracking of hand sanitizer usage allowing hospitals to perform real time training, quality management review, research, and data integration. As stated previously herein, the scanner device is on board the hand sanitizer dispenser unit rather than merely located in the area around the dispenser.

One skilled in the art will appreciate that embodiments are not limited to hand sanitizer dispensers. Rather, the systems and methods set forth herein can be applied to solve a wide variety of user-accountability problems in the medical and other arts where an actuation event needs to be correlated to the user of a device. Furthermore, it will be apparent to those skilled in the art that the above methods and apparatuses may be changed or modified without departing from the general scope of the invention. The invention is intended to include all such modifications and alterations insofar as they come within the scope of the appended claims or the equivalents thereof

Having thus described the invention, it is now claimed:

I/We claim:

1. A hand sanitizer dispenser, comprising:
a dispenser mechanism in fluid communication with a reservoir adapted to contain hand sanitizer liquid;
a microprocessor in electronic communication with the dispensing mechanism and adapted to detect actuation events of the dispensing mechanism, time stamp the actuation event, and record the time stamped actuation event in a data storage component of the dispenser, wherein the microprocessor is further adapted to upload the recorded time stamped actuation event to a remote computer in a format compatible with recording in an electronic medical record of a patient; and
an audio component adapted to issue verbal reminders and tonal reminders from a schedule of reminders, wherein the reminders are derived from a entries in the patient's remote electronic medical record.

2. The dispenser of claim 1, further comprising a reader adapted to read an electronic signal identifying a patient.

3. The dispenser of claim 2, wherein the reader is adapted to read electronic signals from a source selected from one or more of a passive RFID tag, an active RFID tag, a radio frequency beacon, a Wi-Fi beacon, a Bluetooth Low Energy beacon, or a Near Field Technology chip.

4. The dispenser of claim 3 being further adapted to correlate the actuation event with the signal identifying the patient.

5. The dispenser of claim 3, wherein the source of the electronic signals identifying a patient comprises a bracelet, a ring, an adhesive patch, or a subcutaneously implantable device.

6. The dispenser of claim 1, further comprising indicia identifying the dispenser to a network.

7. The dispenser of claim 1, wherein the schedule of reminders is stored onboard the dispenser.

8. The dispenser of claim 1, wherein the schedule or reminder is not stored onboard the dispenser.

9. The dispenser of claim 8, further comprising a detector grid for locating the patient.

10. The dispenser of claim 9, wherein the dispenser is adapted to receive scheduled reminders from the remote computer when the patient is detected nearby the dispenser.

11. The dispenser of claim 1, wherein the dispenser is further adapted to cache the recorded time stamped actuation event.

12. The dispenser of claim 1, further comprising an ad hoc network interface adapted to communicate with nearby dispenser units.

13. The dispenser of claim 12, wherein the ad hoc network interface is adapted to route data from a first remote dispenser to a second remote dispenser, or to the remote computer system.

14. The dispenser of claim 1, wherein the patient's usage of the dispenser is recorded by the remote computer in the patient's electronic medical record.

15. The dispenser of claim 14, wherein the patient's failure to use the dispenser in accordance with a scheduled reminder is recorded by the remote computer in the patient's electronic medical record.

16. The dispenser of claim 1, wherein generation of the schedule of reminders can be suspended if the patient's electronic medical record indicates that the patient is not capable of using the dispenser.

17. The dispenser of claim 1, wherein the dispenser comprises one of a plurality of dispensers adapted to upload time stamped actuation events of the patient to the remote computer.

18. The dispenser of claim 1, further comprising a system adapted to collect hand sanitizer usage data associated with one or more patients and statistically analyze the data.

19. The dispenser of claim 1, further comprising a system adapted isolate an in-house source of infection by analyzing hand sanitizer usage data and electronic medical records of a plurality of patients.

20. A hand sanitizer dispenser, comprising:
a dispenser mechanism in fluid communication with a reservoir adapted to contain hand sanitizer liquid;
a reader adapted to read an electronic signal identifying a patient, wherein the reader is adapted to read electronic signals from a source selected from one or more of a passive RFID tag, an active RFID tag, a radio frequency beacon, a Wi-Fi beacon, a Bluetooth Low Energy beacon, or a Near Field Technology chip;
a microprocessor in electronic communication with the dispensing mechanism and adapted to detect actuation events of the dispensing mechanism, time stamp the actuation event, and record the time stamped actuation event in a data storage component of the dispenser, wherein the microprocessor is further adapted to upload the recorded time stamped actuation event in association with the electronic signal identifying the patient to a remote computer in a format compatible with recording in an electronic medical record of a patient; and
an audio component adapted to issue verbal reminders and tonal reminders from a schedule of reminders, wherein the reminders are derived from a entries in the patient's remote electronic medical record, and wherein the schedule of reminders is stored onboard the dispenser.
